(19) United States
(12) Patent Application Publication
(10) Pub. No.: US 2009/0083098 A1
(43) Pub. Date: Mar. 26, 2009

(54) System and method for an online auction with optimal reserve price

(75) Inventor: Michael Schwarz, Berkeley, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/903,669

(22) Filed: Sep. 24, 2007

(51) Int. Cl. G06Q 10/00; G06F 17/30

(52) U.S. Cl. 705/7

(57) ABSTRACT

An improved system and method for an online auction with optimal reserve price is provided. An auction engine may choose advertisements for web page placements using an optimal reserve price. To estimate an optimal reserve price, a bid may be received from a bidder for the keyword, click-through rates of advertisements allocated web page placement may be obtained for the keyword, and the optimal reserve price may be estimated for the keyword to maximize revenue by determining a distribution for the values per click from the bidders for the keyword. Web page placements may then be allocated for advertisements with bids at least the value of the optimal reserve price and payment for each of the advertisements allocated web page placements may be calculated using the optimal reserve price.

### FIELD OF THE INVENTION

The invention relates generally to computer systems, and more particularly to an improved system and method for an online auction with optimal reserve price.

### BACKGROUND OF THE INVENTION

An online auction is a widely used mechanism for selling advertisements using Internet search engines. Each time a user enters a search term into a search engine, the online auction allocates the advertising space within that user's search results. There are hundreds of millions of separate online auctions conducted every day. Search engines' revenues from online auctions are on the order of ten billion dollars per year. As a result, these advertising auctions are receiving considerable attention from practitioners and academics. For example, Abrams, Z., Revenue Maximization When Bidders Have Budgets, In Proceedings the ACM-SIAM Symposium on Discrete Algorithms, 2006, considers the role of bid increment; Feng, J., Bhargava, H., and Pennock, D., Implementing Sponsored Search in Web Search Engines: Computational Evaluation of Alternative Mechanisms, INFORMS Journal on Computing, 2005, consider the implications of ranking rules; and Borgs, C., et al., Multi-Unit Auctions with Budget-Constrained Bidders, In Proceedings the Sixth ACM Conference on Electronic Commerce, Vancouver, BC, 2005 consider the effect of budgets; and Szymanski, B. and Lee, J., Impact of ROI on Bidding and Revenue in Sponsored Search Advertisement Auctions, Second Workshop on Sponsored Search Auctions, 2006, use simulations to study sponsored search auctions.

However, these theoretical analysis of online auctions have neglected the role and importance of the reserve price for auctioneers in multi-unit auctions. Myerson, R., Optimal Auction Design, Mathematics of Operation Research 6, 58-73, 1981, proves that adding a reserve price to an otherwise efficient auction is an optimal mechanism in a single-unit auction in the case of symmetric bidders. In general, the auction for search advertisements is a multi-unit auction, and optimal mechanism design in multi-unit auctions are an open problem. See for example, Chawla, C., Hartline, J., Klienberg, B., Approximately Optimal Multi-Product Pricing, with and without Lotteries, Bay Algorithmic Game Theory Symposium, September 2006. More particularly, it appears that the role of optimal reserve price has not been investigated for multi-unit auctions in the previous literature, nor has there been any theoretical analysis of optimal reserve prices in sponsored search markets. So profit-seeking search engines may reasonably wonder what reserve price may maximize expected revenues.

What is needed is a system and method that may optimize the reserve price for an online auctioneer to maximize revenue.

### SUMMARY OF THE INVENTION

The present invention provides a system and method for an online auction with optimal reserve price. A reserve price optimizer may be provided for optimizing a reserve price in an online auction to maximize revenue, and an auction engine may be provided for choosing advertisements for web page placements using the optimal reserve price. In an embodiment for conducting an online auction for keywords with an optimal reserve price, the auction engine may estimate an optimal reserve price for a keyword, receive a query having the keyword, and determine a list of advertisements for the keyword using the optimal reserve price. The list of advertisements may then be output to a client device for display with results of the query.

To estimate an optimal reserve price for a keyword in an online advertising auction, a bid may be received from a bidder for the keyword, click-through rates of advertisements allocated web page placement may be obtained for the keyword, and the optimal reserve price may be estimated for the keyword to maximize revenue by determining a distribution for the values per click from the bidders for the keyword. Web page placements may then be allocated for advertisements with bids at least the value of the optimal reserve price and payment for each of the advertisements allocated web page placements in the online advertising auction may be calculated using the optimal reserve price.

The present invention may support many applications for scheduling advertisements in an online auction. For example, online advertising applications may use the present invention to optimize payment for auctioning advertisement placement for keywords of search queries. Or online advertising applications may use the present invention to optimize payments for classes of advertisements to be shown to classes of users. For any of these applications, online advertisement auctions may optimize payments to maximize the revenue of the auctioneer by using an optimal reserve price.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for an online auction with optimal reserve price, in accordance with an aspect of the present invention;

FIG. 3 is a flowchart generally representing the steps undertaken in one embodiment for conducting an online auction with an optimal reserve price, in accordance with an aspect of the present invention; and

FIG. 4 is a flowchart generally representing the steps undertaken in one embodiment for estimating an optimal reserve price for a keyword to maximize revenue for the auctioneer, in accordance with an aspect of the present invention.

### DETAILED DESCRIPTION EXEMPLARY OPERATING ENVIRONMENT

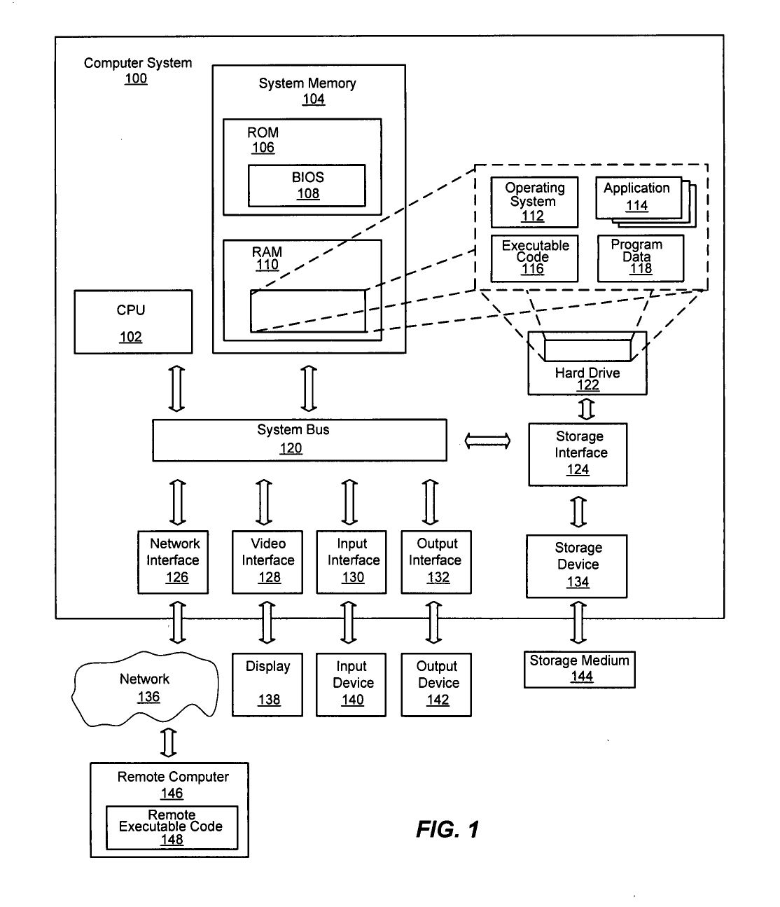

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Online Auction with Optimal Reserve Price

The present invention is generally directed towards a system and method for an online auction with an optimal reserve price. A reserve price may mean herein the lowest price a bidder may pay for participating in an online auction. An optimal reserve price may mean herein an approximate optimal reserve price. A reserve price optimizer may be provided for optimizing a reserve price in an online auction to maximize revenue, and an auction engine may be provided for choosing advertisements for web page placements using the optimal reserve price. As used herein, a web page placement may mean a location on a web page designated for placing an advertisement for display. A web page placement may also include additional information such as a target group of visitors to be shown the advertisement. Web page placements may be allocated for advertisements with bids at least the value of the optimal reserve price and payment for each of the advertisements allocated web page placements in the online advertising auction may be calculated using the optimal reserve price.

As will be seen, the present invention may support many applications for online auctions. For example, an online sponsored search auction may use the present invention to optimize the reserve price to maximize revenue in a sponsored search auction where advertisers may bid on search terms such as keywords. As will be understood, the various block diagrams, flow charts and scenarios described herein are only examples, and there are many other scenarios to which the present invention will apply.

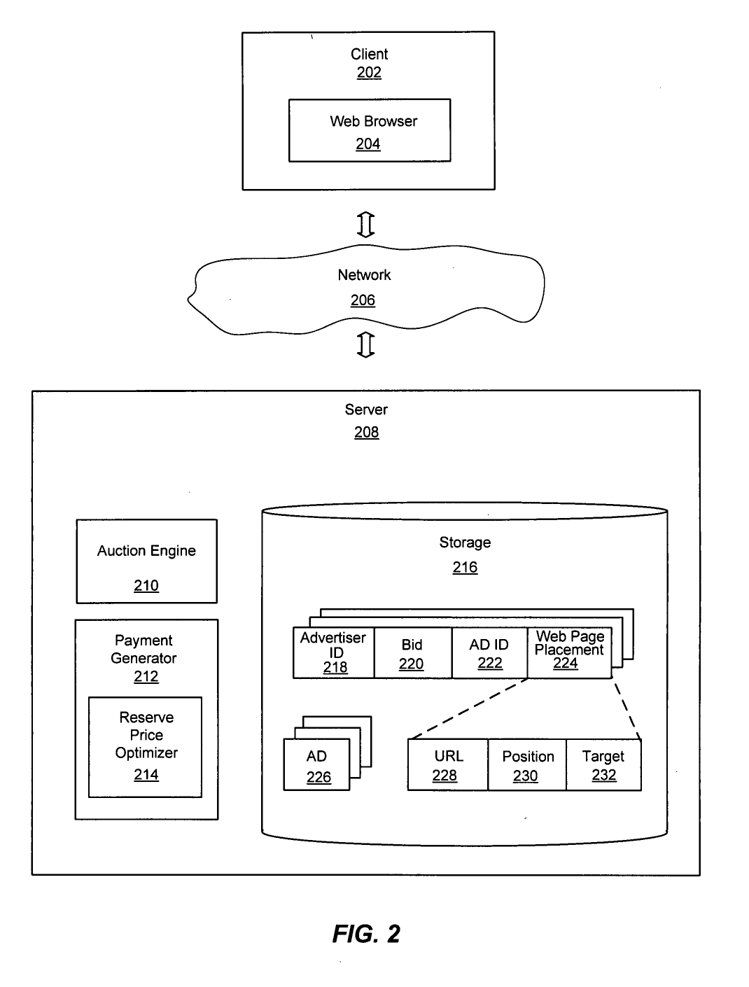

Turning to FIG. 2 of the drawings, there is shown a block diagram generally representing an exemplary architecture of system components for an online auction with optimal reserve price. Those skilled in the art will appreciate that the functionality implemented within the blocks illustrated in the diagram may be implemented as separate components or the functionality of several or all of the blocks may be implemented within a single component. For example, the functionality for the payment generator 212 may be implemented as a component within the auction engine 210. Or the functionality of the reserve price optimizer 214 may be implemented as a separate component from the payment generator 212. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a search request which may be input by a user entering a query. The web browser 204 may include functionality for receiving a query entered by a user and for sending a query request to a server to obtain a list of search results. In general, the web browser 204 may be any type of interpreted or executable software code such as a kernel component, an application program, a script, a linked library, an object with methods, and so forth.

The server 208 may be any type of computer system or computing device such as computer system 100 of FIG. 1. In general, the server 208 may provide services for query processing and may include services for providing a list of auctioned advertisements to accompany the search results of query processing. In particular, the server 208 may include an online auction engine 210 for choosing advertisements for web page placements using an optimal reserve price, a payment generator 212 for calculating payment for auctioning advertisement placement for keywords of search queries using an optimal reserve price, and a reserve price optimizer 214 for optimizing the reserve price to maximize revenue. Each of these modules may also be any type of executable software code such as a kernel component, an application program, a linked library, an object with methods, or other type of executable software code.

The server 208 may be operably coupled to a database of information such as storage 216 that may include an advertiser ID 218 that may be associated with a bid amount 220 for an advertisement referenced by advertisement ID 222 to be di splayed according to the web page placement 224. The web page placement 224 may include a Uniform Resource Locator (URL) 228 for a web page, a position 230 for displaying an advertisement on the web page, and a target ID 232 for referencing a target or group of visitors that may be defined by a profile of characteristics that may match a visitor of the web page. In various embodiments, a target may be defined by demographic information including gender, age, or surfing behavior. Any type of advertisements 226 may be associated with an advertisement ID 218. Advertisers may have multiple advertiser IDs 218 representing several bid amounts for various web page placements and the payments for allocating web page placements for bids may be optimized using an optimal reserve price to maximize the revenue of the auctioneer.

There may be many applications which may use the present invention for scheduling advertisements in an online auction using an optimal reserve price. For example, online advertising applications may use the present invention to optimize payment for auctioning advertisement placement for keywords of search queries. Or online advertising applications may use the present invention to optimize payments for classes of advertisements to be shown to classes of users. For any of these applications, online advertisement auctions may optimize payments to maximize the revenue of the auctioneer by using an optimal reserve price.

A generalized second price auction as used herein may mean any online auction where a bidder's payment may not directly depend upon the bidder's bid but rather may depend upon the web page placement position of the bidder's advertisement and may directly depend upon the bids of other advertisers and attributes of advertisers. Attributes may include clickability of an advertisement, interaction by users, and so forth. Such generalized second price auctions (GSP) are currently used in industry by leading search engine for advertisement auctions. In general, only advertisers who bid at least the reserve price are allowed to participate in a GSP auction with reserve prices. Within a given keyword market, the lowest bidder pays the search engine's reserve price. In contrast, for each advertiser other than the lowest, the advertiser's per-click payment results from the bid of the advertisers immediately below: if all bidders have the same quality and other attributes, the n^{th} highest bidder pays the bid of n+1^{st} bidder. If bidders have different attributes, the bid can be adjusted based on quality, for example, advertisements may be ranked based on the product of bid and quality; however, in a GSP auction the bidder pays the amount necessary to maintain his position. In general, see Edelman, B., Ostrovsky, M., and Schwarz, M., Internet Advertising and the Generalized Second Price Auction: Selling Billions of Dollars Worth of Keywords, American Economic Review, Volume 97, March 2007, for further details on the GSP mechanism.

As motivation for determining an optimal reserve price in a GSP auction, consider in particular a GSP auction with two advertisers and two slots. Suppose the top slot yields 300 clicks per hour, and the bottom slot yields 200 clicks per hour. Furthermore, advertiser A may value a click at $1, while advertiser B may value a click at $0.70. Additionally, consider the reserve price to be set at $0.10.

An envy-free bid of advertiser B may be computed to be $0.30 as discussed in Edelman, B., Ostrovsky, M., and Schwarz, M., Internet Advertising and the Generalized Second Price Auction: Selling Billions of Dollars Worth of Keywords, American Economic Review, Volume 97, March 2007. This result may follow from consideration of advertiser B's perspective on possible changes of advertiser A's bid. For example, if advertiser A were to revise his bid to fall below advertiser B's bid, advertiser B would pay his own bid ($0.30), and he would move into first position, where he would receive 300 clicks per hour. In this case, advertiser B would then realize an hourly surplus of (300)($0.70−$0.30)=$120. But advertiser B gets exactly this same payoff in the second position with a payment of $0.10 (the reserve price), because (200)($0.70−$0.10)=$120 also. So advertiser B is indifferent between the two outcomes.

Now suppose the reserve price increases to $0.40. Then advertiser B's envy-free point increases to $0.50. Advertiser B's envy-free bid is $0.50 because (300)($0.70−$0.50)=200($0.70−$0.40)=$60. Notice that the increase in reserve price has two distinct effects. First, since advertiser B remains in the lowest position (where payment equals the reserve price), advertiser B's payment increases from $0.10 per click to $0.40 per click. So advertiser B's total payment increases from $20 to $80. Second, advertiser A's per-click payment increases from $0.30 to $0.50 since it is set by advertiser B's increased bid. Advertiser A's total payment therefore increases from $90 to $150. Thus, the lowest-bidding advertiser's payment increases penny-for-penny with the reserve price. This is a direct effect of an increased reserve price. Moreover, the lowest bidder's increased bid spur other advertisers to increase their payments in turn. This is the indirect effect of the increased reserve price.

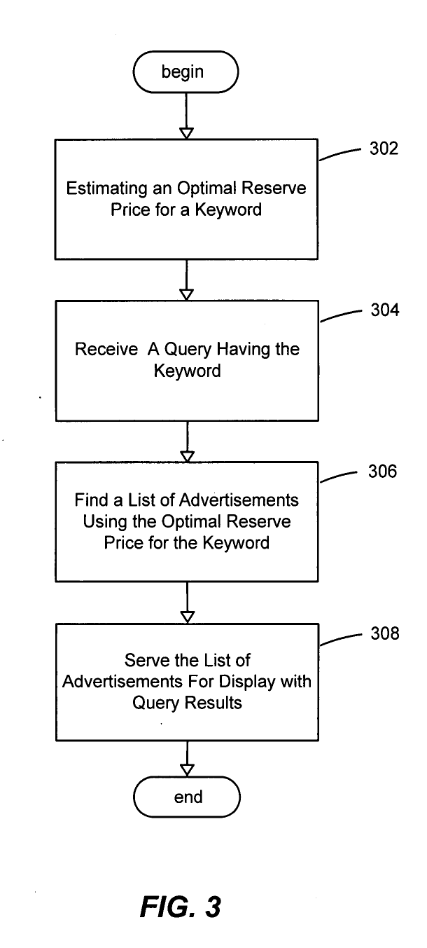

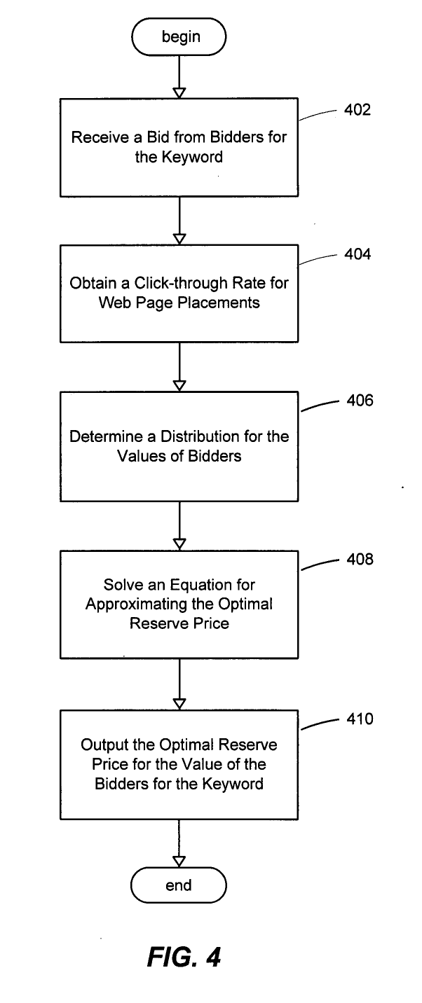

FIG. 3 presents a flowchart generally representing the steps undertaken in one embodiment for conducting an online auction with an optimal reserve price. At step 302, an optimal reserve price may be estimated for a keyword. In a GSP keyword auction, a number of advertisers may bid for j advertising slots based on a keyword. Whenever that keyword appears in the search, j slots of advertisements appear in the results. Each advertiser i may have a private value for each click through which may be denoted by vᵢ. This value may be independent of the slot allocated to an advertisement. The optimal reserve price may be estimated for each keyword based upon a distribution of bidder valuations as described below in conjunction with FIG. 4. Advantageously, this distribution does not depend upon the number of bidders or on the rate at which click-throughs decline from position to position of web page placements.

After an optimal reserve price may be estimated for a keyword, a query having the keyword may be received at step 304. A list of advertisements may be determined for the keyword at step 306 using the optimal reserve price. And the list of advertisements may be displayed with query results at step 308.

FIG. 4 presents a flowchart generally representing the steps undertaken in one embodiment for estimating an optimal reserve price for a keyword to maximize revenue for the auctioneer. At step 402, a bid may be received from bidders for the keyword. Each advertiser i may have a private value for each click through which may be denoted by vᵢ. At step 404, the click-through rate for web page placements may be obtained. Consider αⱼ to denote the click-through rate of position j. At step 406, a probability distribution for the values of bidders may be determined. A probability distribution, f, for the values of bidders may be determined using a number of techniques known to those skilled in the art, such as by computing the probability distribution, f, using historical bidding data, including a known prior distribution of eCPM, such as values representing a bid*quality, for example. Moreover, the probability distribution, f, may represent an estimated distribution of bidder values or may represent an estimated distribution of bidder values adjusted by clickability or other attributes. In various embodiments, such a probability distribution may be determined for each keyword or for groups of keywords.

For example, given νᵢ to denote the value of advertiser i and αⱼ to denote the CTR of position j in an embodiment, consider the value of position j to advertiser i to be denoted by αⱼνᵢ. Furthermore, assume that advertisers' values are independently identically drawn (IID) from a distribution and used to solve the following equation to approximate the Optimal reserve price

$$\frac{1 - F ( v )}{f ( v )} = v .$$

At step 408, the equation may be solved for approximating the optimal reserve price. Consider ν* to denote the solution of

$$\frac{1 - F ( v )}{f ( v )} = v .$$

For additional details of the formal structure for this embodiment, see section IV of Edelman, B., Ostrovsky, M., and Schwarz, M., Internet Advertising and the Generalized Second Price Auction: Selling Billions of Dollars Worth of Keywords, American Economic Review, Volume 97, March 2007. And at step 410, the optimal reserve price, ν*, estimated for the keyword to maximize revenue for the auctioneer may be output.

Based on simulation, ν* approximates the optimal reserve price assuming advertisements have the same clickability, and ν* may approximate the optimal reserve price independent of number of advertisers. Those skilled in the art will appreciate that the estimated optimal reserve price may be further modified to accommodate various marketplaces. For instance, different reserve prices may be determined for different bidder in given marketplace by adjusting the estimated optimal reserve price. In a keyword market, the optimal reserve price may be lowered where advertisements may have high clickability. Or for a particular vertical segment of a marketplace such as electronics, a different reserve price may be determined in given marketplace by adjusting the estimated optimal reserve price. Generally, a different reserve price may be determined for any number of individual marketplaces or combinations of attributes, including bundles of keywords in a given marketplace.

Thus the present invention may use an optimal reserve price to maximize revenue for the auctioneer. Advantageously, revenue may be increased in two ways by increasing the reserve price to an optimal reserve price. First, the lowest-bidding advertiser's payment increases penny-for-penny with the increase of the reserve price to an optimal reserve price. This is the direct effect of an increased reserve price. Second, the lowest bidder's increased bid may spur other advertisers to increase their payments in turn. This is the indirect effect of the reserve price. For each advertiser other than the lowest, the advertiser's per-click payment results from the bid of the advertisers immediately below: if all bidders have the same quality and other attributes, the n^{th} highest bidder pays the bid of n+1^{st} bidder.

As the reserve price increases, payments may increase more sharply on a percentage basis for lower-ranked advertisers than for higher-ranked advertisers. But higher-ranked advertisers generally receive far more clicks than lower-ranked advertisers, due to the greater prominence of top advertising web page placements. Consequently, the total increase in payment from higher-ranked advertisers is generally more than the total increase from lower-ranked advertisers. And in the case where there may be few advertisers bidding, a search engine's gain from setting an optimal reserve price may be large.

As can be seen from the foregoing detailed description, the present invention provides an improved system and method for an online auction with optimal reserve price. An auction engine may choose advertisements for web page placements using an optimal reserve price. To estimate an optimal reserve price in an embodiment, a bid may be received from a bidder for the keyword, click-through rates of advertisements allocated web page placement may be obtained for the keyword, and the optimal reserve price may be estimated for the keyword to maximize revenue by determining a distribution for the values per click from the bidders for the keyword. Web page placements may then be allocated for advertisements with bids at least the value of the optimal reserve price and payment for each of the advertisements allocated web page placements may be calculated using the optimal reserve price. Many applications may use the present invention for scheduling advertisements in an online auction, including optimizing payment for auctioning advertisement placement for keywords of search queries. As a result, the system and method provide significant advantages and benefits needed in contemporary computing, and more particularly in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for an online advertising auction, comprising:
an auction engine for scheduling a plurality of advertisements for a plurality of web page placements in an online advertising auction using an optimal reserve price for maximizing revenue of an auctioneer; and
a storage operably coupled to the auction engine for storing a plurality of bids each associated with an advertisement allocated to web page placements in the online advertising auction.

2. The system of claim 1 further comprising a payment generator operably coupled to the auction engine for calculating payment for each of the plurality of advertisements allocated web page placements in the online advertising auction using the optimal reserve price.

3. The system of claim 1 further comprising a reserve price optimizer operably coupled to the auction engine for estimating the optimal reserve price used in the online advertising auction to maximize revenue for the auctioneer.

4. A computer-readable medium having computer-executable components comprising the system of claim 1.

5. A computer-implemented method for an online advertising auction, comprising:
estimating an optimal reserve price for one or more keywords in an online advertising auction;
receiving a query having the one or more keywords;
determining a list of advertisements using the optimal reserve price in the online advertising auction; and
outputting the list of advertisements for display with results of the query.

6. The method of claim 5 wherein estimating the optimal reserve price for the one or more keywords in the online advertising auction comprises receiving a bid from a bidder for the one or more keywords.

7. The method of claim 5 wherein estimating the optimal reserve price for the one or more keywords in the online advertising auction comprises obtaining click-through rates of advertisements allocated web page placement for the one or more keywords.

8. The method of claim 5 wherein estimating the optimal reserve price for the one or more keywords in the online advertising auction comprises determining the optimal reserve price for the one or more keywords to maximize revenue.

9. The method of claim 8 wherein determining the optimal reserve price for the one or more keywords to maximize revenue comprises determining a probability distribution for a plurality of values per click from a plurality of bidders for the one or more keywords.

10. The method of claim 5 wherein estimating the optimal reserve price for the one or more keywords in an online auction comprises determining the optimal reserve price for the one or more keywords and at least one bidder of a plurality of bidders for the one or more keywords.

11. The method of claim 5 further comprising allocating web page placements for the plurality of advertisements with bids at least the value of the optimal reserve price.

12. The method of claim 5 wherein determining a list of advertisements using the optimal reserve price in the online advertising auction comprises calculating a payment for each of the advertisements allocated web page placements in the online advertising auction using the optimal reserve price.

13. The method of claim 5 wherein outputting the list of advertisements for display with results of the query comprises sending the list of advertisements allocated web page placements in the online advertising auction using the optimal reserve price to a client device for display.

14. A computer-readable medium having computer-executable instructions for performing the method of claim 5.

15. A computer system for an online advertising auction, comprising:
means for determining an optimal reserve price in an online advertising auction; and
means for allocating a plurality of web page placements for a plurality of advertisements with bids at least the value of the optimal reserve price.

16. The computer system of claim 15 further comprising means for outputting the plurality of web page placements for the plurality of advertisements for display.

17. The computer system of claim 15 further comprising means for calculating a payment for each of the plurality of advertisements allocated the plurality of web page placements with bids at least the value of the optimal reserve price.

18. The computer system of claim 15 wherein means for determining the optimal reserve price in the online advertising auction further comprises means for determining an optimal reserve price for a keyword in the online advertising auction.

19. The computer system of claim 18 further comprising means for receiving a query having the keyword.

20. The computer system of claim 15 wherein means for determining an optimal reserve price in an online advertising auction further comprises means for receiving bids for the plurality of advertisements.
